(19) United States
(12) Patent Application Publication
(10) Pub. No.: US 2025/0187720 A1
(43) Pub. Date: Jun. 12, 2025

(54) System and Method for Yaw Moment Control

(71) Applicant: Joby Aero, Inc., Santa Cruz, CA (US)

(72) Inventors: Matthew Epperson, Boulder, CO (US); Thomas Victor Greenhill, Santa Cruz, CA (US); Gregor Veble Mikic, Santa Cruz, CA (US)

(21) Appl. No.: 18/972,265

(22) Filed: Dec. 6, 2024

Related U.S. Application Data
(60) Provisional application No. 63/607,610, filed on Dec. 8, 2023.

(51) Int. Cl. B64C 13/16; B64C 39/10

(52) U.S. Cl. CPC B64C 13/16; B64C 39/10

(57) ABSTRACT

Aircraft control systems and methods include accessing data corresponding to a yaw moment command, computing a control effector adjustment command for one or more control effectors, and adjusting the one or more control effectors of the aircraft to implement the control effector adjustment command. The control effector adjustment command includes deflection adjustments for two control surfaces of the aircraft that are spaced apart on a wing of the aircraft along a transverse direction. The two control surfaces of the aircraft deflect in opposite directions to implement the control effector adjustment command.

### PRIORITY CLAIM

The present application is based on and claims the benefit of U.S. Provisional Application No. 63/607,610 filed on Dec. 8, 2023, which is hereby incorporated by reference herein in its entirety.

### FIELD

The present disclosure relates generally to yaw moment control for aircraft, such as aircraft lacking vertical control surfaces.

### BACKGROUND

Aircraft without vertical control surfaces can offer many advantages over conventional aircraft. For instance, such aircraft can have reduced drag and greater aerodynamic efficiency relative to conventional aircraft with vertical control surfaces. However, aircraft without vertical control surfaces pose technical challenges, including yaw moment control.

Control methods and systems for improved yaw moment control of aircraft, including aircraft without vertical control surfaces, would be useful.

### SUMMARY

In general, aircraft control systems and methods described herein implement a control effector adjustment command by deflecting two control surfaces of the aircraft in opposite directions. The two control surfaces are spaced apart on a wing of the aircraft along a transverse direction and may be elongated along the transverse direction. The opposite control surfaces deflections locally increase drag at the wing and effectuate a yaw moment, which can be significantly greater than a roll moment and a pitch moment generated by the opposite control surfaces deflections. The aircraft control systems and methods may thus advantageously provide yaw moment control for aircraft, such as aircraft without vertical control surfaces. Aspects and advantages of embodiments of the present disclosure will be set forth in part in the following description, or may be learned from the description, or may be learned through practice of the embodiments.

In an example embodiment, an aircraft control method includes: accessing, with a computing device on an aircraft, data corresponding to a yaw moment command; computing, with the computing device, a control effector adjustment command for one or more control effectors of the aircraft to implement the yaw moment command, wherein the control effector adjustment command comprises deflection adjustments for two control surfaces of the aircraft that are spaced apart on a wing of the aircraft along a transverse direction; and adjusting the one or more control effectors of the aircraft to implement the control effector adjustment command, wherein the two control surfaces of the aircraft deflect in opposite directions to implement the control effector adjustment command.

In an example embodiment, an aircraft control system includes one or more processors and one or more non-transitory computer-readable media that store instructions that, when executed by the one or more processors, cause the computing system to perform operations. The operations include: accessing data corresponding to a yaw moment command; computing a control effector adjustment command for one or more control effectors of the aircraft to implement the yaw moment command, wherein the control effector adjustment command comprises deflection adjustments for two control surfaces of the aircraft that are spaced apart on a wing of the aircraft along a transverse direction; and adjusting the one or more control effectors of the aircraft to implement the control effector adjustment command, wherein the two control surfaces of the aircraft deflect in opposite directions to implement the control effector adjustment command.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures.

FIG. 1 is a perspective view of an oblique flying wing aircraft according to an example embodiment of the present disclosure.

FIG. 2 is a top plan view of an oblique flying wing aircraft in a take-off configuration according to an example embodiment of the present disclosure.

FIG. 3 is a top plan view of an oblique flying wing aircraft in a high-speed configuration according to an example embodiment of the present disclosure.

FIG. 4 is another perspective view of an oblique flying wing aircraft according to an example embodiment of the present disclosure.

FIG. 5 is a side elevation view of the example aircraft of FIG. 4.

FIG. 6 is a schematic view of an electrical system for an aircraft according to an example embodiment of the present disclosure.

FIG. 7 is a schematic view of an aircraft control system according to an example embodiment of the present disclosure.

FIG. 8 is a flowchart of an aircraft control method according to an example embodiment of the present disclosure.

FIG. 9 is a schematic view of an aircraft control system according to an example embodiment of the present disclosure.

FIG. 10 is a diagram of example computing components according to an example embodiment of the present disclosure.

Repeat use of reference characters in the present specification and drawings is intended to represent the same or analogous features or elements of the present invention.

### DETAILED DESCRIPTION

Generally, the present disclosure is directed to systems and methods for yaw moment control in aircraft. Yaw control is essential for aircraft flight control, and yaw control can pose challenges in certain aircraft, such as aircraft without vertical control surfaces. To implement a yaw control command, two adjacent control surfaces simultaneously (e.g., and equally) deflect in opposite directions. Such defection can locally increase drag to induce the yaw moment, e.g., with minimal impact on roll and pitch moments. Thus, the aircraft control systems and methods may utilize the two adjacent control surfaces for yaw moment control in aircraft, such as aircraft without vertical control surfaces.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “or” unless otherwise indicated. Also, terms such as “based on” should be understood as “based at least in part on.”

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

The terms “coupled,” “fixed,” “attached to,” and the like refer to both direct coupling, fixing, or attaching, as well as indirect coupling, fixing, or attaching through one or more intermediate components or features, unless otherwise specified herein.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply embodiments of the disclosure. Hence, specific dimensions and other physical characteristics related to the embodiments disclosed herein are not to be considered as limiting.

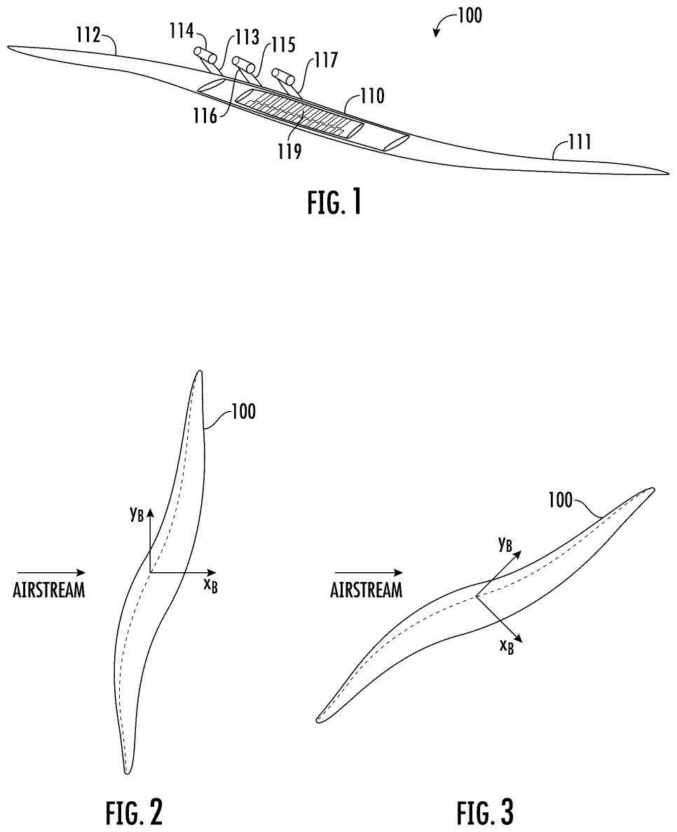

FIG. 1 is a perspective view of an aircraft 100 according to an example embodiment of the present disclosure. Example aspects of the present subject matter are described in greater detail below in the context of the aircraft 100. In the example embodiment shown in FIG. 1, the aircraft 100 is an oblique flying wing aircraft. However, it will be understood that the present subject matter is not limited to oblique flying wing aircraft, such as the aircraft 100. Thus, e.g., the aircraft control systems and methods described herein may be used in or with any suitable aircraft, such as fixed-wing aircraft, VTOL aircraft, flying wing aircraft, multi-modal aircraft, tilt propeller aircraft, tailless aircraft, etc. In particular example embodiments, the aircraft control systems and methods described herein may be used in or with aircraft without vertical control surfaces.

As shown in FIG. 1, the aircraft 100 may include a center-wing segment 110, a left-wing segment 111, and a right-wing segment 112. The center-wing segment 110 may be substantially thicker in the height direction and may be thick enough to allow for passengers in a passenger area 119. A plurality of thrust units 114, 116, 118 may use pivoting pylons 113, 115, 117, which allow for thrusting in different forward flight configurations. The thrust units 116, 114, 118 may be electrically powered fan units with an internal fan. In some example aspects, each of the electrically powered fan units may be powered by a plurality of fuel cells.

The rotation of the thrust units 114, 116, 118 may change the sweep of the aircraft 100, e.g., both due to the change in thrust direction and also due to a rudder effect of the pylons 113, 115, 117. There may also be trimming and control surfaces and devices which assist in the sweep change. It will be understood that the aircraft 100 may be adjusted to various sweep arrangements. Two example configurations of the aircraft 100, with different sweep angles, are shown below in FIGS. 2 and 3. However, it will be understood that aircraft 100 is not limited to the two arrangements shown in FIGS. 2 and 3 and may be adjustable to other sweep angles in example embodiments.

FIG. 2 shows the aircraft 100 in a take-off configuration, in which leading edges of the wing segments 111, 112 are substantially perpendicular to the prevailing airflow. Thus, the arrangement of the aircraft 100 in FIG. 2 may correspond to a low(er) speed flight configuration, e.g., in which the span length of the wing segments 111, 112 is maximized. The span length of the wing segments 111, 112 may extend predominantly perpendicular to the airflow in the take-off configuration. In contrast, the center segment 110 may be swept at an angle from the airflow direction in the take-off configuration.

FIG. 3 shows the aircraft 100 in a high-speed flight configuration, in which the aircraft 100 is rotated relative to the airflow direction. In the high-speed flight configuration shown in FIG. 3, all segments 110, 111, 112 of the aircraft 100 have more sweep than in the take-off configuration shown in FIG. 2. Moreover, the center-wing segment 110 may be more swept relative to the airflow direction than the outer wing segments 111, 112. This asymmetric sweep between the center-wing segment 110 and the left and right-wing segments 111, 112 may allow for a thicker center-wing segment 110, which may be utilized to accommodate pilots, passengers, and other cargo. The higher sweep of the center-wing segment 110 may also reduce or eliminate the wave drag penalty associated with the increased thickness of the center-wing segment 110.

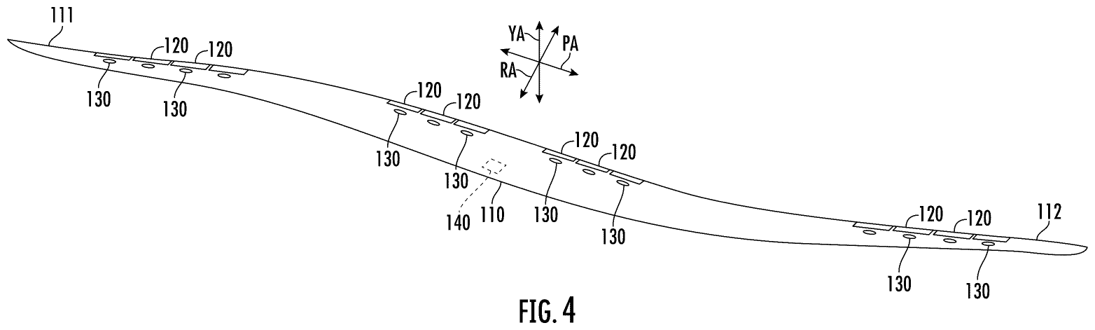

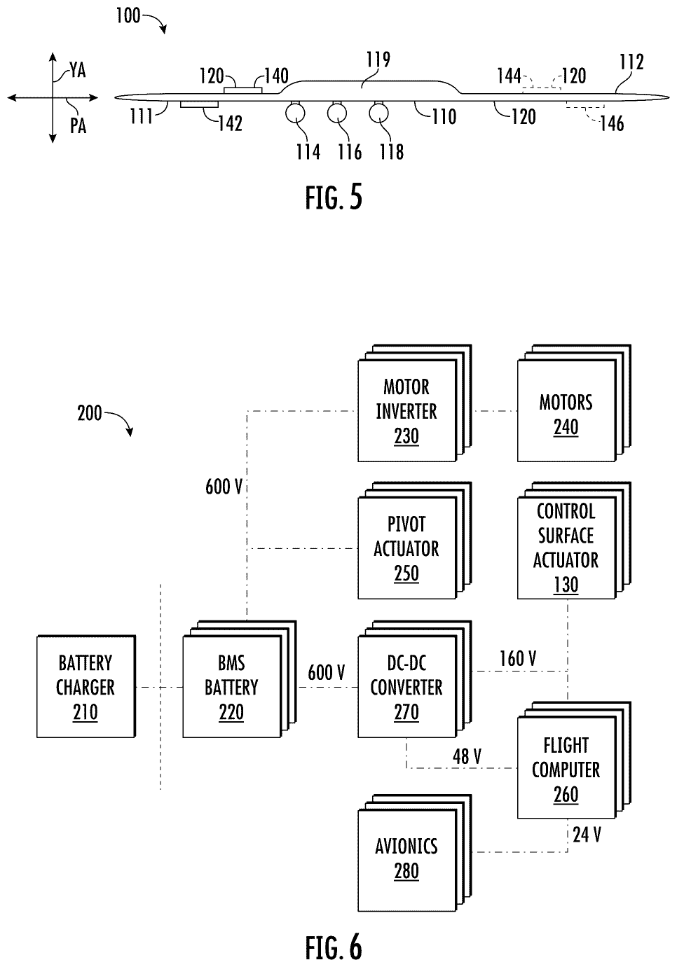

FIG. 4 is a perspective view of the aircraft 100 according to another example embodiment of the present disclosure. FIG. 5 is a front elevation view of the aircraft 100 of FIG. 4. As noted above, the aircraft 100 may include trimming and control surfaces and devices. As an example, with reference to FIG. 4, the aircraft 100 may include a plurality of control surfaces 120 that are adjustable with a plurality of actuators 130 (shown schematically). Moreover, e.g., each of the control surfaces 120 may be adjusted by a respective one or more of the actuators 130. Thus, in response to control commands, actuators 130 may deflect control surfaces 120 in order to adjust an attitude of the aircraft 100. The actuators 130 may be any suitable actuator, such as an electric actuator, a hydraulic actuator, etc.

Deflection of the control surfaces 120 may adjust the attitude of the aircraft 100 about three axes, namely, a yaw axis YA, a pitch axis PA, and a roll axis RA. The yaw axis YA, pitch axis PA, and roll axis RA may be mutually perpendicular. The yaw axis YA may extend along a length of the aircraft 100, e.g., between leading and trailing edges of the segments 110, 111, 112. The pitch axis PA may extend along a width of the aircraft 100, e.g., between the left- and right-wing segments 111, 112. The yaw axis YA may extend along a height of the aircraft 100, e.g., between top and bottom surfaces of the segments 110, 111, 112. It will be understood that the particular orientation of the three axes shown in FIG. 4 is provided by way of example and that the orientation of the axes may vary, e.g., as the sweep of the aircraft 100 changes.

Subsets of the control surfaces 120 may be configured for primarily or predominately adjusting the attitude of the aircraft 100 about one or more of the yaw axis YA, pitch axis PA, and roll axis RA. For example, control surfaces 120 disposed on the left and right-wing segments 111, 112 may be deflected by respective actuators 130 in order to primarily or predominately adjust the attitude of the aircraft 100 about the yaw axis YA, e.g., in the take-off configuration (FIG. 2). Depending upon the pattern of deflection, actuation of the control surfaces 120 disposed on the left and right-wing segments 111, 112 may have little to no effect on the attitude of the aircraft 100 about the pitch axis PA and/or about the roll axis RA due to the limited coupling to such axes. As another example, control surfaces 120 disposed on center-wing segment 110 may be deflected by respective actuators 130 in order to primarily or predominately adjust the attitude of the aircraft 100 about the pitch axis PA and/or about the roll axis RA, e.g., in the take-off configuration. Depending upon the pattern of deflection, actuation of the control surfaces 120 disposed on center-wing segment 110 may have little effect on the attitude of the aircraft 100 about the yaw axis YA due to the limited coupling to such axis.

It will be understood that the subsets of control surfaces 120 described above for adjusting the attitude of the aircraft 100 about the yaw axis YA, pitch axis PA, and roll axis RA may vary depending upon the sweep of the aircraft 100. Moreover, the subsets of the control surfaces 120 for adjusting the attitude of the aircraft 100 about one or more of the yaw axis YA, pitch axis PA, and roll axis RA may vary depending upon the moment required for flight control of the aircraft 100.

In the example embodiment shown in FIG. 4, all the control surfaces 120 are elongated along the pitch axis PA of the aircraft 100. Thus, e.g., none of the control surfaces 120 are elongated along the roll axis RA of the aircraft 100 in the example embodiment shown in FIG. 4. Moreover, none of the control surfaces 120 may be vertically oriented in example embodiments. However, it will be understood that, in certain example embodiments, the aircraft 100 may include control surfaces 120 that are elongated along the roll axis RA of the aircraft 100. As discussed in greater detail below, the aircraft 100 may utilize the control surfaces 120 to induce a moment about the yaw axis YA, e.g., despite the aircraft 100 lacking vertical control surfaces that are elongated along the roll axis RA of the aircraft 100 or as an alternative or complement to vertical control surfaces that are elongated along the roll axis RA.

As shown in FIG. 4, the aircraft 100 may also include a processing device or computing device 102 (shown schematically) that may be generally configured to facilitate operation of at least a portion of the aircraft 100. In this regard, as discussed in greater detail below, thrust units 114, 116, 118 and/or control surfaces 120 of the aircraft 100 may be adjusted by the computing device 102 to assist with stabilizing the aircraft 100 and/or implementing control commands.

As used herein, the terms “processing device,” “computing device,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “computing device” are not necessarily restricted to a single element but may include any suitable number, type, and configuration of processing devices integrated in any suitable manner to facilitate aircraft operation.

The computing device 102 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices may store information and/or data accessible by the one or more processors, including instructions that may be executed by the one or more processors. It should be appreciated that the instructions may be software written in any suitable programming language or may be implemented in hardware. Additionally, or alternatively, the instructions may be executed logically and/or virtually using separate threads on one or more processors.

For example, the computing device 102 may be operable to execute programming instructions or micro-control code associated with operation of the aircraft 100. In this regard, the instructions may be software or any set of instructions that when executed by the processing device, cause the processing device to perform operations, such as running one or more software applications, adjusting the operating parameters of aircraft 100, etc. Moreover, it should be noted that the computing device 102 as disclosed herein is capable of and may be operable to perform any methods, method steps, or portions of methods as disclosed herein. For example, in some example embodiments, methods disclosed herein may be embodied in programming instructions stored in the memory and executed by the computing device 102.

Again, it will be understood that the aircraft 100 is provided by way of example. The present subject matter may also be used in or with other aircraft in alternative example embodiments. For example, the present subject matter may be used in or with fixed-wing aircraft, VTOL aircraft, flying wing aircraft, multi-modal aircraft, tilt propeller aircraft, tailless aircraft, etc. The aircraft may include an all-electric powertrain, e.g., with battery powered electric motors, for the propulsion units. In alternative example embodiments, may include a hybrid powertrain, such as a gas-electric hybrid with an internal-combustion generator, or an internal-combustion powertrain, such as a gas-turbine engine, a turboprop engine, etc.

As discussed in greater detail below, deflection of the control surfaces 120 may induce a moment about the yaw axis YA. For instance, in the example embodiment shown in FIG. 5, the control surfaces 120 include a first pair of control surfaces 140, 142 and a second pair of control surfaces 144, 146. The first pair of control surfaces 140, 142 are positioned adjacent each other and spaced apart along the pitch axis PA of the aircraft 100 on the right-wing segment 112 of the aircraft 100. Thus, both the control surfaces 140, 142 are positioned on the same side of the center-wing segment 110. Conversely, both the control surfaces 144, 146 are positioned on the opposite side of the center-wing segment 110. Moreover, the second pair of control surfaces 140, 142 are positioned adjacent each other and spaced apart along the pitch axis PA of the aircraft 100 on the left-wing segment 111 of the aircraft 100.

Deflection of the first pair of control surfaces 140, 142 on the right-wing segment 112 (e.g., while the second pair of control surfaces 144, 146 remain undeflected or aligned with the left-wing segment 111) can induce a negative yaw moment. Conversely, deflection of the second pair of control surfaces 144, 146 on the left-wing segment 111 (e.g., while the first pair of control surfaces 140, 142 remain undeflected or aligned with the right-wing segment 112) can induce a positive yaw moment. Thus, selective deflection of either the first pair of control surfaces 140, 142 or the second pair of control surfaces 144, 146 may implement the yaw moment command.

In example embodiments, the first pair of control surfaces 140, 142 may be oriented generally parallel to the pitch axis PA of the aircraft 100. Thus, e.g., the first pair of control surfaces 140, 142 may be elongated along the pitch axis PA of the aircraft 100. Moreover, the first pair of control surfaces 140, 142 may be pivotable relative to the right-wing segment 112 of the aircraft 100, e.g., about an axis parallel to the pitch axis PA of the aircraft 100. The first pair of control surfaces 140, 142 may also be oriented such that neither of the first pair of control surfaces 140, 142 is oriented generally parallel to the yaw axis YA and/or elongated along the yaw axis YA. In example embodiments, a length of the first pair of control surfaces 140, 142 along the pitch axis PA may be greater than a width of the first pair of control surfaces 140, 142 along the roll axis RA and/or a height of the first pair of control surfaces 140, 142 along the yaw axis YA, as shown in FIGS. 4 and 5.

The second pair of control surfaces 144, 146 may also be oriented generally parallel to the pitch axis PA of the aircraft 100. Thus, e.g., the second pair of control surfaces 144, 146 may be elongated along the pitch axis PA of the aircraft 100. Moreover, the second pair of control surfaces 144, 146 may be pivotable relative to the left-wing segment 111 of the aircraft 100, e.g., about an axis parallel to the pitch axis PA of the aircraft 100. The second pair of control surfaces 144, 146 may also be oriented such that neither of the second pair of control surfaces 144, 146 is oriented generally parallel to the yaw axis YA and/or elongated along the yaw axis YA. In example embodiments, a length of the second pair of control surfaces 144, 146 along the pitch axis PA may be greater than a width of the second pair of control surfaces 144, 146 along the roll axis RA and/or a height of the second pair of control surfaces 144, 146 along the yaw axis YA, as shown in FIGS. 4 and 5.

As noted above, the first pair of control surfaces 140, 142 are positioned adjacent to each other. For instance, the first pair of control surfaces 140, 142 may be spaced apart by no greater than one meter (1 m), such as no greater than a half meter (0.5 m), such as no greater than a quarter meter (0.25 m), such as no greater than a tenth meter (0.1 m), or less, along the pitch axis PA of the aircraft 100. Similarly, the second pair of control surfaces 144, 146 are positioned adjacent to each other. For instance, the second pair of control surfaces 144, 146 may be spaced apart by no greater than one meter (1 m), such as no greater than a half meter (0.5 m), such as no greater than a quarter meter (0.25 m), such as no greater than a tenth meter (0.1 m), or less, along the pitch axis PA of the aircraft 100.

In example embodiments, a second control surface 142 of the first pair of control surfaces 140, 142 may be positioned outward of a first control surface 140 of the first pair of control surfaces 140, 142 on the right-wing segment 112. To implement the positive yaw moment command, the second control surface 142 of the first pair of control surfaces 140, 142 may deflect downwardly (e.g., about the pitch axis PA), and the first control surface 140 of the first pair of control surfaces 140, 142 may deflect upwardly (e.g., about the pitch axis PA). In example embodiments, a second control surface 146 of the second pair of control surfaces 144, 146 may be positioned outward of a first control surface 146 of the second pair of control surfaces 144, 146 on the left-wing segment 111. To implement the negative yaw moment command, the second control surface 146 of the second pair of control surfaces 144, 146 may deflect downwardly (e.g., about the pitch axis PA), and the first control surface 144 of the second pair of control surfaces 144, 146 may deflect upwardly (e.g., e.g., about the pitch axis PA). Such deflection of the control surface 140, 142, 144, 146 to implement the yaw moment command can advantageously provide more yaw moment effectiveness, e.g., due to the increased drag that can be generated by downward deflection.

FIG. 6 is schematic view of an electrical system 200 for the aircraft 100. As shown, the electrical system may include batteries 220. In an example, each of the batteries 220 may supply two power inverters 230. The nominal voltage of the batteries 220 may be six hundred volts (600V) in example embodiments. Each of the propulsion motors 240 may include two sets of windings, with each motor 240 powered by two inverters 230, one for each set of windings. The two inverters 230 powering a single motor 240 each may be supplied power by different batteries 220. In addition to supplying power to the motor inverters 230, the battery 220 may also supply power to pivot actuators 250, which are used to rotate pivoting pylons 113, 115, 117 during various flight modes, such as the take-off configuration and the high-speed flight configuration.

A flight computer 260 may monitor the current from each of the motor inverters 230, which supply power to the winding sets in the motors 240. The flight computer 260 may also control the motor current supplied to each of the windings of the motors 240. In example embodiments, the batteries 220 may also supply power to one or more actuators 270, such as control surface actuators 130, configured to adjust the position of various control surfaces on the aircraft 100.

The actuators 270 may receive power through a DC-DC converter 270, which may step the voltage from six hundred volts (600V) to one hundred and sixty volts (160V), for example. A suite of avionics 280 may also be coupled to the flight computer 260. A battery charger 210 may be used to recharge the batteries 220, and the battery charger 210 may be located external to the aircraft 100 and ground based.

The flight computer 260 may be configured to generate commands that may be transmitted to and interpreted by the inverters 230 and/or actuators 250, 270 to control aircraft flight. In example embodiments with a plurality of flight computers 260, each of the flight computers 260 may be a substantially identical instance of the same computer architecture and components, but can additionally or alternatively be instances of distinct computer architectures and components (e.g., generalized processors manufactured by different manufacturers). The flight computers 260 may include CPUs, GPUs, TPUs, ASICS, microprocessors, and/or any other suitable set of processing systems. In example embodiments, each of the flight computers 260 performs substantially identical operations (e.g., processing of data, issuing of commands, etc.) in parallel, and are connected (e.g., via the distribution network) to the same set of flight components. FIG. 12 provides additional detail regarding example components of a computing system, such as a flight computer 260.

The flight computer 260 may be programmed to assist control operation of the aircraft 100. For example, flight computer 260 may receive positioning data and/or navigation data from avionics 280, and flight computer 260 may generate commands that may be transmitted to and interpreted by the inverters 230 and/or actuators 250, 270 to control aircraft flight in order navigate the aircraft 100 to a destination.

In example embodiments with a plurality of flight computers 260, each of the flight computers 260 may be a substantially identical instance of the same computer architecture and components, but can additionally or alternatively be instances of distinct computer architectures and components (e.g., generalized processors manufactured by different manufacturers). The flight computer 260 may include CPUs, GPUs, TPUs, ASICS, microprocessors, and/or any other suitable set of processing systems. In example embodiments, each of the flight computer 260 performs distinct operations (e.g., processing of data, estimating of flight parameters, etc.) in parallel, and are connected (e.g., via the distribution network) to the flight computer 260. FIG. 12 provides additional detail regarding example components of a computing system, such as the flight computer 260.

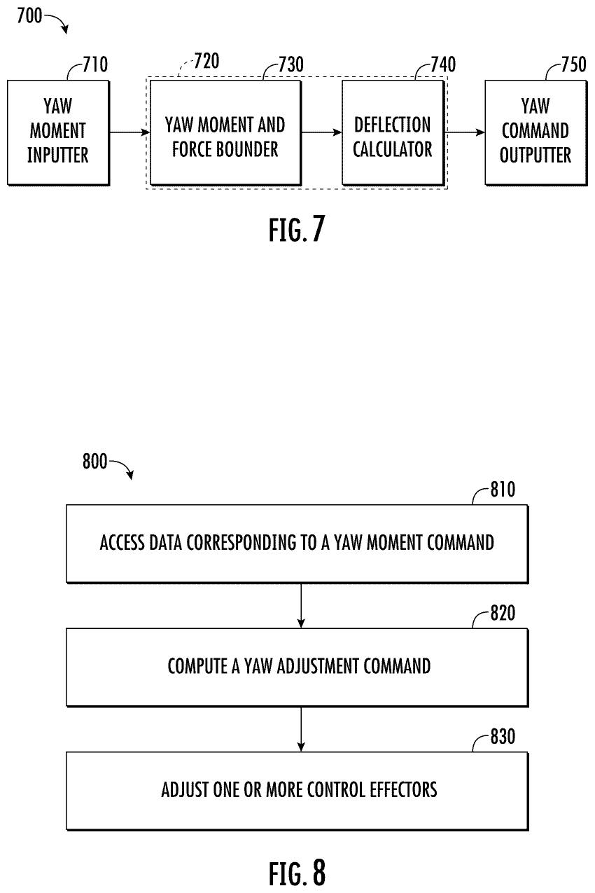

FIG. 7 is a schematic view of portions of a system 700 for yaw moment control according to an example embodiment of the present disclosure. The system 700 may be implemented by or with the flight computer 260 in certain example embodiments, and the flight computer 260 may be programmed to implement the system 700. Thus, system 700 is described in greater detail below in the context of aircraft 100 and the flight computer 260. However, it will be understood that the system 700 may be utilized in or with other aircraft and computing devices in other example embodiments. As discussed in greater detail below, the system 700 may assist with yaw moment control in an associated aircraft, such as aircraft without vertical control surfaces.

The system 700 may include a yaw moment inputter 710. The yaw moment inputter 710 may access data corresponding to a yaw moment command. The yaw moment command may correspond to a requested or desired yaw moment for an aircraft, e.g., for maneuvering, stabilization, and other control operations of the aircraft. In example embodiments, the yaw moment command may include a pilot-generated yaw moment command, which may correspond to a pilot commanded adjustment of the yaw moment for the aircraft. Thus, e.g., the yaw moment inputter 710 may receive data corresponding to the pilot-generated yaw moment command from a pilot interface of the aircraft 100, such as rudder pedals, a twist stick, etc. In example embodiments, the yaw moment command may include an autonomous flight control system-generated yaw moment command, which may correspond to an autonomous flight control system commanded adjustment of the yaw moment for the aircraft. Thus, e.g., the yaw moment inputter 710 may receive data corresponding to the autonomous flight control system-generated yaw moment command from an autonomous flight system of the aircraft 100 that controls flight of the aircraft 100. In example embodiments, the yaw moment command may include a stability control system-generated yaw moment command, which may correspond to a stability control system commanded adjustment of the yaw moment for the aircraft. Thus, e.g., the yaw moment inputter 710 may receive data corresponding to the stability control system-generated yaw moment command from a stability control system of the aircraft 100 that assists stability of the aircraft 100. The yaw moment inputter 710 may also access other yaw moment commands in other example embodiments.

The system 700 may also include a control effector adjustment commander 720, which may access the data corresponding to the yaw moment command from the yaw moment inputter 710. Based on the yaw moment command, the control effector adjustment commander 720 may compute a control effector adjustment command for one or more control effectors of the aircraft to implement the yaw moment command. Thus, e.g., the control effector adjustment commander 720 may compute the control effector adjustment command to implement the yaw moment command from the yaw moment inputter 710. Moreover, the control effector adjustment command may correspond to control data for the control effectors of the aircraft 100, such as inverters 230, actuators 250, and/or actuators 270. Thus, the control effector adjustment command computed by the control effector adjustment commander 720 may include one or more of deflections for control surfaces 120, pivot angles for pivoting pylons 113, 115, 117, and power outputs for thrust units 114, 116, 118 for implementing the yaw moment command.

As described in greater detail below, the control effector adjustment commander 720 may compute the control effector adjustment command, which include opposite deflections for two of the control surfaces 120, such as the first pair of control surfaces 140, 142 or the second pair of control surfaces 144, 146. As an example, the control effector adjustment command may include deflection of the first pair of control surfaces 140, 142 on the right-wing segment 112 (e.g., while the second pair of control surfaces 144, 146 remain aligned with the left-wing segment 111) to induce a positive yaw moment. Conversely, the control effector adjustment command may include deflection of the second pair of control surfaces 144, 146 on the left-wing segment 111 (e.g., while the first pair of control surfaces 140, 142 remain aligned with the right-wing segment 112) to induce a negative yaw moment. As may be seen from the above, a pair (or two, three, or more pairs) of adjacent control surfaces 120 may be simultaneously deflected in opposite directions to implement the yaw moment command, e.g., by locally increase drag at the pair (or two, three, or more pairs) of adjacent control surfaces 120 with minimal impact on roll and pitch moments.

The control effector adjustment commander 720 may use any method to compute the opposite deflections for pair of control surfaces to implement the yaw moment command. It will be understood that the following methods and algorithms are provided by way of example and are not intended as limitations to the described examples.

For deflections that are not excessively large, the increase on local drag due to deflection of the pair (or two, three, or more pairs) of adjacent control surfaces 120 may be dominated by a change in induced drag, which is a quadratic effect. In example embodiments, the control effector adjustment commander 720 may include a model for yaw moments and forces for the aircraft. For instance, the model for yaw moments and forces may be the following

$${C}_{{m}_{y a}} ( δ ) = {a}_{{m}_{y a}} \cdot {δ}^{2} + {b}_{{m}_{y a}} \cdot δ$$

$${C}_{{f}_{r a}} ( δ ) = {a}_{{f}_{r a}} \cdot {δ}^{2} + {b}_{{f}_{r a}} \cdot δ$$

where
   Cₘ_{_{ya}} is a moment coefficient about a yaw axis,
   aₘ_{_{ya}} is a quadratic term for the moment coefficient about the yaw axis,
   bₘ_{_{ya}} is a linear term for the moment coefficient about the yaw axis,
   C_{f}_{ᵣₐ} is a force coefficient along a roll axis,
   a_{f}_{ᵣₐ} is a quadratic term for the force coefficient along the roll axis, and
   b_{f}_{ᵣₐ} is a linear term for the force coefficient along the roll axis.
      Each pair of control surfaces (such as the first pair of control surfaces 140, 142 on the right-wing segment 112 and the second pair of control surfaces 144, 146 on the left-wing segment 111) may be modeled with the two quadratic relationships above, namely Cₘ_{_{ya}}(δ) and C_{f}_{ᵣₐ}(δ). The first pair of control surfaces 140, 142 on the right-wing segment 112 may be referred to with the notation “r”, and the second pair of control surfaces 144, 146 on the left-wing segment 111 may be referred to with the notation “l”.

To implement the yaw moment command, two of the control surfaces 120 may be simultaneously and equally deflected in opposite directions. Moreover, simultaneous, equal, and opposite deflection of a pair (or two, three, or more pairs) of adjacent control surfaces 120 on the right-wing segment 112 may induce a positive yaw moment, and simultaneous, equal, and opposite deflection of a pair (or two, three, or more pairs) of adjacent control surfaces 120 on the left-wing segment 111 may induce a negative yaw moment. Thus, deflection of left and right control surfaces 120 may be given as follows

$${δ}_{l} = {δ}_{1} = - {δ}_{2} , {δ}_{l} \geq 0$$

$${δ}_{r} = {δ}_{3} = - {δ}_{4} , {δ}_{r} \geq 0$$

where
   δₗ is deflection of control surfaces on a left side of the aircraft,
   δ₁ is deflection of a first control surface on the left side of the aircraft,
   δ₂ is deflection of a second control surface on the left side of the aircraft,
   δᵣ is deflection of control surfaces on a right side of the aircraft,
   δ₃ is deflection of a first control surface on the right side of the aircraft, and
   δ₄ is deflection of a second control surface on the right side of the aircraft.
      In example embodiments, the first control surfaces may be positioned outward of the second control surfaces on the left and right sides of the aircraft, respectively. When the control surfaces are cambered airfoils, the first control surfaces may be deflected downwardly, e.g., because downward deflection of cambered airfoils may produce more drag, which can advantageously provide more yaw moment effectiveness. The quadratic relationships for Cₘ_{_{ya}} and C_{f}_{ᵣₐ} for the left and right sides may be given as follows

$${C}_{{m}_{y a}} ( {δ}_{l} ) = ( {a}_{{m}_{y {a}_{1}}} + {a}_{{m}_{y {a}_{2}}} ) \cdot {δ}_{l}^{2} + ( {b}_{{m}_{y {a}_{1}}} - {b}_{{m}_{y {a}_{2}}} ) \cdot {δ}_{l} = {a}_{{m}_{y {a}_{l}}} \cdot {δ}_{l}^{2} + {b}_{{m}_{y {a}_{l}}} \cdot {δ}_{l}$$

$${C}_{{f}_{r a}} ( {δ}_{l} ) = ( {a}_{{f}_{r {a}_{1}}} + {a}_{{m}_{r {a}_{2}}} ) \cdot {δ}_{l}^{2} + ( {b}_{{m}_{r {a}_{1}}} - {b}_{{m}_{r {a}_{2}}} ) \cdot {δ}_{l} = {a}_{{m}_{r {a}_{l}}} \cdot {δ}_{l}^{2} + {b}_{{m}_{r {a}_{l}}} \cdot {δ}_{l}$$

$${C}_{{m}_{y a}} ( {δ}_{r} ) = ( {a}_{{m}_{y {a}_{3}}} + {a}_{{m}_{y {a}_{4}}} ) \cdot {δ}_{r}^{2} + ( {b}_{{m}_{y {a}_{3}}} - {b}_{{m}_{y {a}_{4}}} ) \cdot {δ}_{r} = {a}_{{m}_{y {a}_{r}}} \cdot {δ}_{r}^{2} + {b}_{{m}_{y {a}_{r}}} \cdot {δ}_{r}$$

$${C}_{{f}_{r a}} ( {δ}_{r} ) = ( {a}_{{f}_{r {a}_{3}}} + {a}_{{m}_{r {a}_{4}}} ) \cdot {δ}_{r}^{2} + ( {b}_{{m}_{r {a}_{3}}} - {b}_{{m}_{r {a}_{4}}} ) \cdot {δ}_{r} = {a}_{{m}_{r {a}_{r}}} \cdot {δ}_{r}^{2} + {b}_{{m}_{r {a}_{r}}} \cdot {δ}_{r}$$

Deflection of the first and second control surfaces on the left side of the aircraft induce a negative Cₘ_{_{ya}}, and deflection of the first and second control surfaces on the right side of the aircraft induce a positive Cₘ_{_{ya}}. Deflection of either the first and second control surfaces on the left side of the aircraft or the first and second control surfaces on the right side of the aircraft both produce a negative C_{f}_{ᵣₐ}, drag.

As shown in FIG. 7, in example embodiments, the control effector adjustment commander 720 may include a yaw moment and force bounder 730 and a deflection calculator 740. The control effector adjustment commander 720 may be configured to prioritize Cₘ_{_{ya}} tracking over C_{f}_{ᵣₐ} tracking. Thus, for a

$${C}_{{m}_{y {a}_{ref}}}$$

and a

$${C}_{{f}_{r {a}_{ref}}} ,$$

the

$${C}_{{f}_{r {a}_{ref}}}$$

may be bounded such that the

$${C}_{{m}_{y {a}_{ref}}}$$

may be tracked. Frist, the yaw moment and force bounder 730 may determine the max available Cₘ_{_{ya}} along the direction of

$${C}_{{m}_{y {a}_{ref}}} .$$

### The

$${C}_{{f}_{r {a}_{ref}}}$$

is negative, produces drag. In example embodiments, the yaw moment and force bounder 730 may be configured to bound

$${C}_{{m}_{y {a}_{ref}}}$$

and the

$${C}_{{f}_{r {a}_{ref}}}$$

via the following algorithm

```
$if {C}_{{m}_{{ya}_{ref}}} > 0 then ⊳ the right side must produce more drag than the left side$
    $// bound {C}_{{m}_{{ya}_{ref}}} to what ’ s physically relizable$
  ${C}_{{m}_{{ya}_{min}}} = EvaluateQuadratic ( a = {a}_{{m}_{{ya}_{l}}} , b = {b}_{{m}_{{ya}_{l}}} , δ = {δ}_{max} )$
  ${C}_{{m}_{{ya}_{max}}} = EvaluateQuadratic ( a = {a}_{{m}_{{ya}_{r}}} , b = {b}_{{m}_{{ya}_{r}}} , δ = {δ}_{max} )$
  ${C}_{{m}_{{ya}_{ref}}} = Clamp Min Max ( {C}_{{m}_{{ya}_{min}}} , {C}_{{m}_{{ya}_{max}}} , {C}_{{m}_{{ya}_{ref}}} )$
```

| | |
|---|---|
| // compute the upper bound | [symbol] the upper bound is determined by the |
| | deflection required to achieve the desired |
| | yaw moment |

```
  ${δ}_{{r}_{min}} = SolveQuadratic ( a = {a}_{{m}_{{ya}_{r}}} , b = {b}_{{m}_{{ya}_{r}}} , c = {C}_{{m}_{{ya}_{ref}}} )$
  ${C}_{{fra}_{upper bound}} = EvaluateQuadratic ( a = {a}_{{fra}_{r}} , b = {b}_{{f}_{{ra}_{r}}} , δ = {δ}_{{r}_{min}} )$
    // compute the lower bound
  ${C}_{{m}_{{ya}_{r}}} = EvaluateQuadratic ( a = {a}_{{m}_{{ya}_{r}}} , b = {b}_{{m}_{{ya}_{r}}} , δ = {δ}_{max} )$
```

```

[symbol]
solve for the left sude deflection that
    cancels any unwanted addtional yaw
    moment produced from generating
    max drag on the right side
```

```
  ${δ}_{l} = SolveQuadratic ( a = {a}_{{m}_{{ya}_{l}}} , b = {b}_{{m}_{{ya}_{l}}} , c = {C}_{{m}_{{ya}_{ref}}} - {C}_{{m}_{{ya}_{r}}} )$
  C_{fra}_{ₗ} = EvaluateQuadratic (a = a_{ya}_{ₗ}, b = b_{fra}_{ₗ}, δ = δₗ)
  C_{fra}_{_{lower bound}} = C_{fra}_{ₗ} +C_{fra}_{ᵣ}
```

| | |
|---|---|
| else | [symbol] the left side must produce more drag |
| | than the right side |

```
    // repeat the same algorithm with the left side as the first side
end if
  C_{fra}_{_{ref}} = ClampMinMax(C_{fra}_{_{ref}}, C_{fra}_{_{lower bound}}, C_{fra}_{_{upper bound}})
```

In example embodiments, a negative deflection of the pair of control surfaces may be null, e.g., due to the required deflection direction of the pair of control surfaces. Thus, e.g., the solution of the quadratic equation may be bounded on an interval [0, δₘₐₓ] to provide only positive roots. When no positive roots exist, the pair of control surfaces may be maintained at a normal or zero deflection state. In example embodiments, the deflection calculator 740 may be configured to calculate the roots of the quadratic equation via the following algorithm

```
discriminant = b * b − 4 * a * (−c)
if ∥a∥ ≤ = 0 or discriminant < 0 then
  result = 0
else
  $root 1 = ( - b + \sqrt{discriminant} ) / ( 2 * a )$
  $root 2 = ( - b - \sqrt{discriminant} ) / ( 2 * a )$
  result = root1 >= 0 ? root1:root2
end if
```

Once physically realizable (bounded)

$${C}_{{m}_{y {a}_{ref}}} and {C}_{{f}_{r {a}_{ref}}}$$

are identified by the yaw moment and force bounder 730 with the prioritization of

$${C}_{{m}_{y {a}_{ref}}} over {C}_{{f}_{r {a}_{ref}}} ,$$

a unique solution for the simultaneous, equal, and opposite deflection of a pair (or two, three, or more pairs) of adjacent control surfaces may be may be tracked by the deflection calculator 740 to realizable commands. In example embodiments, the solution may be a bivariate quadratic as defined above, and Newton's method may be used to iteratively converge on the solution. For instance, the analytical Jacobian of the bivariate quadratic may be closed form and defined by

$$\frac{\partial [ \begin{matrix}{C}_{{m}_{ya}} \\ {C}_{fra}\end{matrix} ]}{\partial [ \begin{matrix}{δ}_{l} \\ {δ}_{r}\end{matrix} ]}$$

The deflection calculator 740 may be programmed as a two-dimensional Newton solver with a fixed number of iterations used to converge to the unique solution for

$$[ \begin{matrix}{δ}_{l} \\ {δ}_{r}\end{matrix} ] .$$

As shown in FIG. 7, the system 700 may also include a yaw moment outputter 750. The yaw moment outputter 750 may access data corresponding to the control effector adjustment command. The control effector adjustment command may correspond to instructions or commands for one or more control effectors of the aircraft to implement the yaw moment command. Thus, the yaw moment outputter 750 may be in signal communication with one or more control effectors of the aircraft, and the yaw moment outputter 750 may transmit control signals to the one or more control effectors of the aircraft, e.g., for maneuvering, stabilization, and other control operations of the aircraft.

The control effector adjustment command may include various adjustments for the one or more control effectors of the aircraft. Thus, the yaw moment outputter 750 may be in communication with various systems of the aircraft 100 to transmit the control effector adjustment command and thereby implement the yaw moment command. In example embodiments, the control effector adjustment command may include control data for actuators 270. Thus, e.g., the yaw moment outputter 750 may transmit data corresponding to opposite (e.g., simultaneous and/or equal) deflection adjustments for the control surfaces 120 to induce a moment about the yaw axis YA. In example embodiments, the control effector adjustment command may also include control data for inverters 230 of the motors 240. Thus, e.g., the yaw moment outputter 750 may transmit data corresponding to the power settings for the inverters 230 of the motors 240 to induce a moment about the yaw axis YA. In example embodiments, the control effector adjustment command may also include control data for actuators 250. Thus, e.g., the yaw moment outputter 750 may transmit data corresponding to the pivot adjustments for the actuators 250 of the pivoting pylons 113, 115, 117 to induce a moment about the yaw axis YA. The yaw moment outputter 750 may also access yaw moment commands for other control effectors of the aircraft in other example embodiments. As may be seen from the above, the control effectors of the aircraft may adjust in response to the control effector adjustment command from the yaw moment outputter 750.

In general, the control effector adjustment command includes deflecting two control surfaces of the aircraft in opposite directions. For example, the control effector adjustment command may include deflecting the first pair of control surfaces 140, 142 on the right-wing segment 112 (e.g., while the second pair of control surfaces 144, 146 remain undeflected or aligned with the left-wing segment 111) to induce a negative yaw moment. Conversely, the control effector adjustment command may include deflecting the second pair of control surfaces 144, 146 on the left-wing segment 111 (e.g., while the first pair of control surfaces 140, 142 remain undeflected or aligned with the right-wing segment 112) to induce a positive yaw moment. Such deflection of the control surfaces 120 can locally increase drag to induce the yaw moment, e.g., that is significantly greater than a roll moment and a pitch moment for the aircraft.

As noted above, the system 700 may be configured for yaw moment control of an aircraft, e.g., without vertical control surfaces. Moreover, the system 700 may deflect control surfaces to locally increase drag and induce the yaw moment. In certain example embodiments, the system 700 may generate a nonlinear (e.g., quadratic) local increase in drag at two control surfaces by deflecting the two control surfaces in opposite directions. Thus, the system 700 may advantageously allocate two degrees of freedom for the aircraft, namely yaw moment and force along the roll axis. However, the system 700 (and the yaw moment control provided by the system 700) may be utilized in combination with other control methods and systems for allocating other degrees of freedom, such as roll moment, pitch moment, and total thrust. Thus, e.g., system 700 may operate in combination with other systems for complete control of the aircraft.

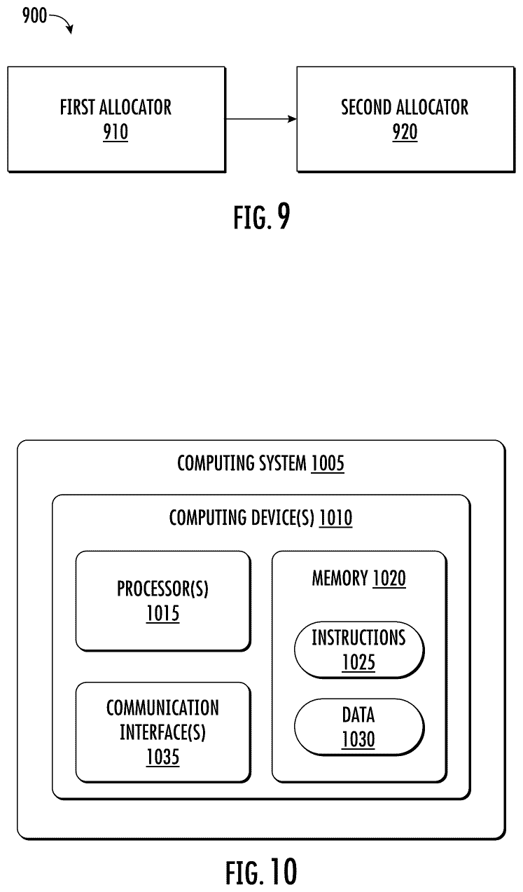

FIG. 9 is a schematic view of portions of a system 900 for aircraft control allocations according to an example embodiment of the present disclosure. The system 900 may be implemented by or with the flight computer 260 in certain example embodiments, and the flight computer 260 may be programmed to implement the system 900. Thus, system 900 is described in greater detail below in the context of aircraft 100 and the flight computer 260. However, it will be understood that the system 900 may be utilized in or with other aircraft and computing devices in other example embodiments. As discussed in greater detail below, the system 900 may assist with nonlinear and linear control allocations for the aircraft.

As shown in FIG. 9, an aircraft control system 900 may include a two-step allocation system, wherein a first allocator 910 is configured for leveraging the quadratic nature of the drag and yaw moment as a function of effector deflection, and a second allocator 920 is configured for adjusting control effectors to achieve the desired rolling and yawing moments. The first allocator 910 may include or correspond to the system 700 in certain example embodiments. Thus, the first allocator 910 may be configured for yaw moment control of an aircraft, e.g., without vertical control surfaces, by deflecting control surfaces in opposite directions to locally increase drag and induce the yaw moment as described above.

The second allocator 920 may be configured for subsequent adjustments of control effectors of the aircraft. Thus, e.g., after computing the control effector adjustment command to implement the yaw moment command with the first allocator 910. The second allocator 920 may compute adjustments of control effectors of the aircraft, such as inverters 230, actuators 250, and/or actuators 270, to implement roll moment control, pitch moment control, and/or total thrust. However, the second allocator 920 may compute adjustments of control effectors from the deflections for two of the control surfaces 120 (e.g., and other control effectors configurations) required to implement the yaw moment control from the first allocator 910. For instance, the second allocator 920 may utilize the output of the first allocator 910 as a calibration or baseline setting for the control effectors and then compute adjustments of control effectors of the aircraft to implement the roll moment control, the pitch moment control, and/or the total thrust from the calibration or baseline setting of the first allocator 910. The second allocator 920 may command relatively small control surface deflections about (e.g., in combination with or against) the control surface deflections of the first allocator 910.

The allocation techniques used by the second allocator 920 may utilize a simpler linear model (e.g., relative to the more complex nonlinear model of the first allocator 910), or a more complex hybrid linear-nonlinear model. For example, the second allocator 920 may be programed to implement conventional linear allocation methods for control effector actuation commands (e.g., control surface deflections, propulsor thrusts, etc.) to implement roll moment control, pitch moment control, and/or total thrust. The simpler linear model may be less computationally expensive and thus assist with real-time implementation of the system 900 during aircraft operation, e.g., while also using the more computationally expensive nonlinear model for yaw moment control.

When the output of the first allocator 910 results in large deflections due to high demand of yaw moment or drag, flow separation on those control surfaces may occur. Under such circumstances, the relationship between rolling and pitching moments with additional deflection may become significantly nonlinear. To account for this nonlinearity, the second allocator 920 may optionally use a hybrid linear-nonlinear model. The combined model may be used to leverage the accuracy of the nonlinear model while maintaining the beneficial convergence properties associated with solving for effector commands using the linear model. This hybrid linear-nonlinear model allows the second allocator 920 to iterate sequentially over a nonlinear residual, wherein the linear model is used to solve for each sequential step. Using this approach, the second allocator 920 may provide very tight convergence of rolling and pitching moments even when the solution to the first allocator 910 results in large deflections.

As may be seen from the above, the system 900 may thus utilize both nonlinear and linear allocation for control effectors of an aircraft. Thus, e.g., the system 900 may utilize nonlinear effects to produce large control surface deflections for yaw moment control via the first allocator 910, and the second allocator 920 may utilize linear allocation for other degrees of freedom. In the system 900, the control effector commands of the first allocator 910 and the second allocator 920 may be combined to resolve the desired overall forces and moments for controlling the aircraft. In example embodiments, any conflict between roll or pitch moments produced during the initial first allocator 910 caused by mismatch in the control authority of the two control surfaces may be cancelled by the control effector commands from the second allocator 920.

FIG. 8 illustrates a method 800 for yaw moment control of an aircraft. Method 800 is described in greater detail below in the context of the aircraft 100 and system 700. However, it will be understood that method 800 may be used in or with other aircraft and control systems to provide yaw moment control.

At 810, a computing system (e.g., system 700) may access data corresponding to a yaw moment command. In example embodiments, the yaw moment command may be a pilot-generated yaw moment command, an autonomous flight control system-generated yaw moment command, or a stability control system-generated yaw moment command. Thus, the yaw moment command may correspond to a requested or desired yaw moment for an aircraft, e.g., for maneuvering, stabilization, and other control operations of the aircraft.

At 820, the computing system (e.g., system 700) may compute a control effector adjustment command for one or more control effectors of the aircraft to implement the yaw moment command. The control effector adjustment command may correspond to control data for the control effectors of the aircraft, such as inverters, actuators, etc. As an example, the control effector adjustment command computed by the control effector adjustment commander 720 may include one or more of deflections for control surfaces 120, pivot angles for pivoting pylons 113, 115, 117, and power outputs for thrust units 114, 116, 118 for implementing the yaw moment command. In particular, the control effector adjustment command includes deflection adjustments for two control surfaces of the aircraft that are spaced apart on a wing of the aircraft along a transverse direction.

At 830, the computing system (e.g., system 700) may adjust the one or more control effectors of the aircraft to implement the control effector adjustment command. The two control surfaces of the aircraft deflect in opposite directions to implement the control effector adjustment command. The two control surfaces may be positioned adjacent each other and may be elongated along the transverse direction on the wing. Deflecting the two control surfaces can advantageously locally increase drag at the wing and thereby induce a yaw moment that is significantly greater than a roll moment and a pitch moment for the aircraft.

FIG. 8 depicts steps performed in a particular order for purposes of illustration and discussion. Those of ordinary skill in the art, using the disclosures provided herein, will understand that the steps of any of the methods discussed herein may be adapted, rearranged, expanded, omitted, or modified in various ways without deviating from the scope of the present disclosure. Moreover, although aspects of method 800 are explained using aircraft 100 and system 700 as an example, it should be appreciated that these methods may be applied to the operation of any aircraft or control system.

FIG. 10 depicts example system components of a computing system 1005 according to example implementations of the present disclosure. The computing system 1005 may include one or more computing devices 1010. The computing devices 1010 of the computing system 1005 may include one or more processors 1015 and a memory 1020. The processors 1015 can be any suitable processing device (e.g., a processor core, a microprocessor, an ASIC, a FPGA, a controller, a microcontroller, etc.) and may be one processor or a plurality of processors that are operatively connected. The memory 1020 can include one or more non-transitory computer-readable storage media, such as RAM, ROM, EEPROM, EPROM, one or more memory devices, flash memory devices, etc., and combinations thereof.

The memory 1020 may store information that can be accessed by the processors 1015. For instance, the memory 1020 (e.g., one or more non-transitory computer-readable storage mediums, memory devices) may include computer-readable instructions 1025 that can be executed by the processors 1015. The instructions 1025 may be software written in any suitable programming language or may be implemented in hardware. Additionally, or alternatively, the instructions 1025 may be executed in logically or virtually separate threads on processors 1015.

For example, the memory 1020 may store instructions 1025 that when executed by the processors 1015 cause the processors 1015 to perform operations such as any of the operations and functions of any of the computing systems (e.g., aircraft system) or computing devices (e.g., the flight computer), as described herein.

The memory 1020 may store data 1030 that can be obtained, received, accessed, written, manipulated, created, or stored. The data 1030 may include, for instance, input data, trim values, output data, or other data/information described herein. In some implementations, the computing devices 1010 may access from or store data in one or more memory devices that are remote from the computing system 1005.

The computing devices 1010 can also include a communication interface 1035 used to communicate with one or more other systems. The communication interface 1035 may include any circuits, components, software, etc. for communicating via one or more networks. In some implementations, the communication interface 1035 may include for example, one or more of a communications controller, receiver, transceiver, transmitter, port, conductors, software or hardware for communicating data/information.

FIG. 10 illustrates one example computing system 1005 that may be used to implement the present disclosure. Other computing systems can be used as well. Computing tasks discussed herein as being performed at computing devices onboard the aircraft may instead be performed remote from the aircraft (e.g., a network connected computing system), or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

As may be seen from the above, the present subject matter may advantageously assist with providing control systems and methods for yaw moment control for aircraft, such as aircraft without vertical control surfaces. To implement the yaw control command, two adjacent control surfaces may simultaneously deflect in opposite directions.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

### EXAMPLE EMBODIMENTS

First example embodiment: An aircraft control method, comprising: accessing, with a computing device on an aircraft, data corresponding to a yaw moment command; computing, with the computing device, a control effector adjustment command for one or more control effectors of the aircraft to implement the yaw moment command, wherein the control effector adjustment command comprises deflection adjustments for two control surfaces of the aircraft that are spaced apart on a wing of the aircraft along a transverse direction; and adjusting the one or more control effectors of the aircraft to implement the control effector adjustment command, wherein the two control surfaces of the aircraft deflect in opposite directions to implement the control effector adjustment command.
Second example embodiment: The aircraft control method of the first example embodiment, wherein the yaw moment command comprises one or more of: a pilot-generated yaw moment command; an autonomous flight control system-generated yaw moment command; and a stability control system-generated yaw moment command.
Third example embodiment: The aircraft control method of either the first or second example embodiment, wherein: the control effector adjustment command further comprises an adjustment for a thrust unit of the aircraft; and the thrust unit is adjusted to implement the control effector adjustment command.
Fourth example embodiment: The aircraft control method of any one of the first through third example embodiments, wherein the adjustment for the thrust unit comprises one or both of a power setting of the thrust unit and a pivot angle of the thrust unit.
Fifth example embodiment: The aircraft control method of any one of the first through fourth example embodiments, wherein the aircraft does not include vertical control surfaces.
Sixth example embodiment: The aircraft control method of any one of the first through fifth example embodiments, wherein the two control surfaces are positioned adjacent to each other on the wing of the aircraft, and the two control surfaces are elongated along the transverse direction on the wing of the aircraft.
Seventh example embodiment: The aircraft control method of any one of the first through sixth example embodiments, wherein the two control surfaces are spaced apart by no more than one meter on the wing of the aircraft.
Eighth example embodiment: The aircraft control method of any one of the first through seventh example embodiments, wherein: the two control surfaces of the aircraft comprise a first control surface and a second control surface, the second control surface positioned outward of the first control surface on the wing of the aircraft; and the second control surface deflects downwardly and the first control surface deflects upwardly to implement the control effector adjustment command.
Nineth example embodiment: The aircraft control method of any one of the first through eighth example embodiments, wherein adjusting the one or more control effectors of the aircraft to implement the control effector adjustment command induces a yaw moment that is significantly greater than a roll moment and a pitch moment for the aircraft.
Tenth example embodiment: The aircraft control method of any one of the first through nineth example embodiments, wherein deflecting the two control surfaces of the aircraft in opposite directions to implement the control effector adjustment command locally increases a drag at the wing.
Eleventh example embodiment: An aircraft control system, comprising: one or more processors; and one or more non-transitory computer-readable media that store instructions that, when executed by the one or more processors, cause the computing system to perform operations, the operations comprising accessing data corresponding to a yaw moment command, computing a control effector adjustment command for one or more control effectors of the aircraft to implement the yaw moment command, wherein the control effector adjustment command comprises deflection adjustments for two control surfaces of the aircraft that are spaced apart on a wing of the aircraft along a transverse direction, and adjusting the one or more control effectors of the aircraft to implement the control effector adjustment command, wherein the two control surfaces of the aircraft deflect in opposite directions to implement the control effector adjustment command.
Twelfth example embodiment: The aircraft control system of the eleventh example embodiment, wherein the yaw moment command is one of: a pilot-generated yaw moment command; an autonomous flight control system-generated yaw moment command; and a stability control system-generated yaw moment command.
Thirteenth example embodiment: The aircraft control system of either the eleventh or twelfth example embodiment, wherein: the control effector adjustment command further comprises an adjustment for a thrust unit of the aircraft; and the thrust unit is adjusted to implement the control effector adjustment command.
Fourteenth example embodiment: The aircraft control system of any one of the eleventh through thirteenth example embodiments, wherein the adjustment for the thrust unit comprises one or both of a power setting of the thrust unit and a pivot angle of the thrust unit.
Fifteenth example embodiment: The aircraft control system of any one of the eleventh through fourteenth example embodiments, wherein the aircraft does not include vertical control surfaces.
Sixteenth example embodiment: The aircraft control system of any one of the eleventh through fifteenth example embodiments, wherein the two control surfaces are positioned adjacent to each other on the wing of the aircraft, and the two control surfaces are elongated along the transverse direction on the wing of the aircraft.
Seventeenth example embodiment: The aircraft control system of any one of the eleventh through sixteenth example embodiments, wherein the two control surfaces are spaced apart by no more than one meter on the wing of the aircraft.
Eighteenth example embodiment: The aircraft control system of any one of the eleventh through eighteenth example embodiments, wherein: the two control surfaces of the aircraft comprise a first control surface and a second control surface, the second control surface positioned outward of the first control surface on the wing of the aircraft; and the second control surface deflects downwardly and the first control surface deflects upwardly to implement the control effector adjustment command.
Nineteenth example embodiment: The aircraft control system of any one of the eleventh through eighteenth example embodiments, wherein adjusting the one or more control effectors of the aircraft to implement the control effector adjustment command induces a yaw moment that is significantly greater than a roll moment and a pitch moment for the aircraft.
Twentieth example embodiment: The aircraft control system of any one of the eleventh through nineteenth example embodiments, wherein deflecting the two control surfaces of the aircraft in opposite directions to implement the control effector adjustment command locally increases a drag at the wing.
Twenty-first example embodiment: A control method, substantially as herein described.
Twenty-second example embodiment: A control system, substantially as herein described.

What is claimed is:

1. An aircraft control method, comprising:
accessing, with a computing device on an aircraft, data corresponding to a yaw moment command;
computing, with the computing device, a control effector adjustment command for one or more control effectors of the aircraft to implement the yaw moment command, wherein the control effector adjustment command comprises deflection adjustments for two control surfaces of the aircraft that are spaced apart on a wing of the aircraft along a transverse direction; and
adjusting the one or more control effectors of the aircraft to implement the control effector adjustment command, wherein the two control surfaces of the aircraft deflect in opposite directions to implement the control effector adjustment command.

2. The aircraft control method of claim 1, wherein the yaw moment command comprises one or more of:
a pilot-generated yaw moment command;
an autonomous flight control system-generated yaw moment command; and
a stability control system-generated yaw moment command.

3. The aircraft control method of claim 1, wherein:
the control effector adjustment command further comprises an adjustment for a thrust unit of the aircraft; and
the thrust unit is adjusted to implement the control effector adjustment command.

4. The aircraft control method of claim 3, wherein the adjustment for the thrust unit comprises one or both of a power setting of the thrust unit and a pivot angle of the thrust unit.

5. The aircraft control method of claim 1, wherein the aircraft does not include vertical control surfaces.

6. The aircraft control method of claim 1, wherein the two control surfaces are positioned adjacent to each other on the wing of the aircraft, and the two control surfaces are elongated along the transverse direction on the wing of the aircraft.

7. The aircraft control method of claim 1, wherein the two control surfaces are spaced apart by no more than one meter on the wing of the aircraft.

8. The aircraft control method of claim 1, wherein:
the two control surfaces of the aircraft comprise a first control surface and a second control surface, the second control surface positioned outward of the first control surface on the wing of the aircraft; and
the second control surface deflects downwardly and the first control surface deflects upwardly to implement the control effector adjustment command.

9. The aircraft control method of claim 1, wherein adjusting the one or more control effectors of the aircraft to implement the control effector adjustment command induces a yaw moment that is significantly greater than a roll moment and a pitch moment for the aircraft.

10. The aircraft control method of claim 1, wherein deflecting the two control surfaces of the aircraft in opposite directions to implement the control effector adjustment command locally increases a drag at the wing.

11. An aircraft control system, comprising:
one or more processors; and
one or more non-transitory computer-readable media that store instructions that, when executed by the one or more processors, cause the computing system to perform operations, the operations comprising
accessing data corresponding to a yaw moment command,
computing a control effector adjustment command for one or more control effectors of the aircraft to implement the yaw moment command, wherein the control effector adjustment command comprises deflection adjustments for two control surfaces of the aircraft that are spaced apart on a wing of the aircraft along a transverse direction, and
adjusting the one or more control effectors of the aircraft to implement the control effector adjustment command, wherein the two control surfaces of the aircraft deflect in opposite directions to implement the control effector adjustment command.

12. The aircraft control system of claim 11, wherein the yaw moment command is one of:
a pilot-generated yaw moment command;
an autonomous flight control system-generated yaw moment command; and
a stability control system-generated yaw moment command.

13. The aircraft control system of claim 11, wherein:
the control effector adjustment command further comprises an adjustment for a thrust unit of the aircraft; and
the thrust unit is adjusted to implement the control effector adjustment command.

14. The aircraft control system of claim 13, wherein the adjustment for the thrust unit comprises one or both of a power setting of the thrust unit and a pivot angle of the thrust unit.

15. The aircraft control system of claim 11, wherein the aircraft does not include vertical control surfaces.

16. The aircraft control system of claim 11, wherein the two control surfaces are positioned adjacent to each other on the wing of the aircraft, and the two control surfaces are elongated along the transverse direction on the wing of the aircraft.

17. The aircraft control system of claim 11, wherein the two control surfaces are spaced apart by no more than one meter on the wing of the aircraft.

18. The aircraft control system of claim 11, wherein:
the two control surfaces of the aircraft comprise a first control surface and a second control surface, the second control surface positioned outward of the first control surface on the wing of the aircraft; and
the second control surface deflects downwardly and the first control surface deflects upwardly to implement the control effector adjustment command.

19. The aircraft control system of claim 11, wherein adjusting the one or more control effectors of the aircraft to implement the control effector adjustment command induces a yaw moment that is significantly greater than a roll moment and a pitch moment for the aircraft.

20. The aircraft control system of claim 11, wherein deflecting the two control surfaces of the aircraft in opposite directions to implement the control effector adjustment command locally increases a drag at the wing.
